(19) United States
(12) Patent Application Publication
(10) Pub. No.: US 2014/0186715 A1
(43) Pub. Date: Jul. 3, 2014

(54) METHOD FOR MANUFACTURING SEPARATOR, SEPARATOR, AND BATTERY USING SEPARATOR

(71) Applicants: Jung Seong LEE, Uiwang-si (KR); Kee Wook KIM, Uiwang-si (KR); Sang Ho LEE, Uiwang-si (KR); Yong Bae LEE, Uiwang-si (KR); Jung Sue JANG, Uiwang-si (KR); Jun Ho CHUNG, Uiwang-si (KR); Jae Hyun CHO, Uiwang-si (KR)

(72) Inventors: Jung Seong LEE, Uiwang-si (KR); Kee Wook KIM, Uiwang-si (KR); Sang Ho LEE, Uiwang-si (KR); Yong Bae LEE, Uiwang-si (KR); Jung Sue JANG, Uiwang-si (KR); Jun Ho CHUNG, Uiwang-si (KR); Jae Hyun CHO, Uiwang-si (KR)

(21) Appl. No.: 14/142,778

(22) Filed: Dec. 28, 2013

(30) Foreign Application Priority Data
Dec. 28, 2012 (KR) 10-2012-0156443
Dec. 28, 2012 (KR) 10-2012-0156444
Dec. 18, 2013 (KR) 10-2013-0158086
Dec. 18, 2013 (KR) 10-2013-0158091

(51) Int. Cl. B29C 71/00; H01M 2/16; B29C 47/00; H01M 2/14

(52) U.S. Cl. CPC B29C 71/0009; H01M 2/145; H01M 2/1653; B29C 47/0021
USPC 429/246; 429/249; 264/211; 264/203

(57) ABSTRACT

A method for manufacturing a polyolefin-based porous separator includes forming a sheet containing a polyolefin-based resin and a diluent, extracting the diluent from the sheet by using an extracting apparatus, and forming a separator by drying the extracted sheet using a drying apparatus provided with an inlet. The shortest distance between an outlet of the extracting apparatus and an inlet of the drying apparatus may be 100 mm or less.

### CROSS-REFERENCE TO RELATED APPLICATIONS

Korean Patent Application No. 10-2012-0156443 and Korean Patent Application No. 10-2012-0156444, each filed on Dec. 28, 2012, and Korean Patent Application No. 10-2013-0158086 and Korean Patent Application No. 10-2013-0158091, each filed on Dec. 18, 2013, in the Korean Intellectual Property Office, and entitled: “Method for Manufacturing Separator, Separator, and Battery using Separator,” are incorporated by reference herein in their entireties.

### BACKGROUND

1. Field

Embodiments relate to a method for manufacturing a separator, a separator, and a battery using the separator.

2. Description of the Related Art

A separator for an electrochemical battery indicates an intermediate sheet capable of separating a cathode and an anode from each other in the battery and continuously maintaining ionic conductivity to charge and discharge the battery.

### SUMMARY

Embodiments are directed to a method for manufacturing a polyolefin-based porous separator, the method including forming a sheet containing a polyolefin-based resin and a diluent, extracting the diluent from the sheet by using an extracting apparatus, and forming a separator by drying the extracted sheet using a drying apparatus provided with an inlet. The shortest distance between an outlet of the extracting apparatus and an inlet of the drying apparatus may be 100 mm or less.

Embodiments are also directed to a method for manufacturing a polyolefin-based porous separator, the method including forming a sheet containing a polyolefin-based resin and a diluent, extracting the diluent from the sheet, forming a separator by drying the extracted separator using a drying apparatus provided with an inlet, and supplying water to the separator after the extracting of the diluent and before the drying of the extracted separator.

Embodiments are also directed to a polyolefin-based porous separator of which an average thickness is 7 μm to 20 μm, an average deviation of thicknesses with respect to the average thickness is 5% or less, an average puncture strength is 690 gf or more, and an average deviation of puncture strengths with respect to the average puncture strength is 10% or less.

Embodiments are also directed to an electrochemical battery, including a cathode, an anode, a polyolefin-based porous separator, and an electrolyte. The polyolefin-based porous separator may be a separator according to an embodiment.

### BRIEF DESCRIPTION OF THE DRAWINGS

Features will become apparent to those of skill in the art by describing in detail example embodiments with reference to the attached drawings in which:

FIG. 1 illustrates a diagram schematically showing stages in a method for manufacturing a separator according to an example embodiment;

FIG. 2 illustrates a diagram schematically showing a diluent extracting process and a drying process in a method for manufacturing the separator according to an example embodiment;

FIG. 3 illustrates a method for manufacturing a separator according to another example embodiment; and

FIG. 4 illustrates Table 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. In the drawing figures, the dimensions of layers and regions may be exaggerated for clarity of illustration. Like reference numerals refer to like elements throughout.

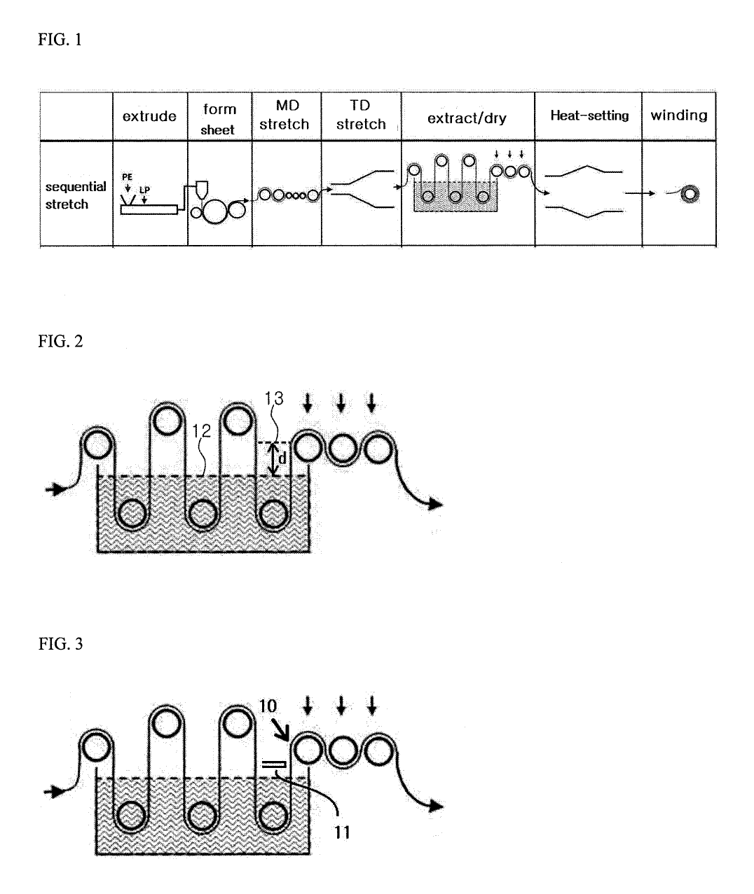

Hereinafter, a method for manufacturing a separator according to an example embodiment will be described with reference to FIGS. 1 and 2.

FIG. 1 illustrates a diagram schematically showing stages in a method for manufacturing a separator according to an example embodiment, and FIG. 2 illustrates a diagram schematically showing a diluent extracting process and a drying process in a method for manufacturing the separator according to an example embodiment.

According to an example embodiment, a method for manufacturing a polyolefin-based porous separator may include: forming a sheet containing a polyolefin-based resin and a diluent; extracting the diluent from the sheet by using an extracting apparatus; and drying the extracted sheet by using a drying apparatus provided with an inlet to thereby form a separator. The shortest distance between an outlet of the extracting apparatus and an inlet of the drying apparatus may be 100 mm or less.

According to the present example embodiment, the method for manufacturing the polyolefin-based porous separator may be a wet method including kneading a polyolefin-based resin and a diluent at a high temperature at which a polyolefin-based resin composition is molten to prepare a single phase. The method may further include phase-separating the polyolefin and the diluent in a cooling process, extracting the diluent, and forming pores using the diluent.

A porous separator in which a thickness of the separator is thinly and uniformly controlled, a size of the formed pores is uniformly controlled, and a mechanical strength is excellent may be manufactured using the wet method according to an example embodiment. An example embodiment may provide a separator having excellent uniformity in physical properties manufactured by controlling a diluent extracting process and a drying process among processes for manufacturing the separator.

According to the present example embodiment, first, referring to FIG. 1, a polyolefin-based resin composition and a diluent are introduced into an extruder to be extruded. The polyolefin-based resin composition and the diluent may be introduced into the extruder at the same time or in sequence.

The polyolefin-based resin composition may be a composition including only at least one kind of polyolefin-based resin or a mixed composition including at least one kind of polyolefin-based resin, other resins except for polyolefin-based resin, and/or inorganic materials.

Examples of the polyolefin-based resin include polyethylene (PE), polypropylene (PP), polybutylene (PB), polyisobutylene (PIB), poly-4-methyl-1-pentene (PMP), and the like. The polyolefin-based resin may be used alone or as a mixture of two or more kinds. Thus, the polyolefin-based resin may be used alone, or as a copolymer thereof or a mixture thereof.

Examples of the other resins except for the polyolefin-based resins include polyamide (PA), polybutylene terephthalate (PBT), polyethyleneterephthalate (PET), polychlorotrifluoroethylene (PCTFE), polyoxymethylene (POM), polyvinyl fluoride (PVF), polyvinylidene fluoride (PVdF), polycarbonate (PC), polyarylate (PAR), polysulfone (PSF), polyetherimide (PEI), and the like. The other resins except for the polyolefin-based resins may be used alone or as a mixture of two or more kinds thereof.

Examples of the inorganic material include alumina, calcium carbonate, silica, barium sulfate, talc, and the like, and the inorganic material may be used alone or as a mixture of two or more kinds.

The diluent may be a suitable organic compound having a single phase formed with the polyolefin-based resin (or a polyolefin-based resin or a mixture of other kinds of resins) at an extrusion temperature. Examples of the diluent include fluidic paraffin such as nonane, decane, decalin, liquid paraffin (LP) (or paraffin oil) and the like; aliphatic or cyclic hydrocarbons such as paraffin wax; phthalic acid esters such as dibutyl phthalate, dioctyl phthalate, and the like; fatty acids having 10 to 20 carbon atoms such as palmitic acid, stearic acid, oleic acid, linoleic acid, linolenic acid, and the like; and fatty acid alcohols having 10 to 20 carbon atoms such as palmitic acid alcohol, stearic acid alcohol, oleic acid alcohol, and the like. The diluent may be used alone or as a mixture of two or more kinds thereof. For example, a liquid paraffin, which is a paraffin as an example of an organic material having a low molecular weight and having a molecular structure similar to that of polyolefin among the diluents, may be used. A liquid paraffin may be harmless to humans and have a high boiling point and little volatile components, and may be appropriate to be used as a diluent in a wet method.

Then, referring to FIG. 1, a casting process is performed on a gel phased reactant obtained by the extrusion, so as to be manufactured in a sheet type. A stretch magnification or expansion of the separator may be controlled by controlling a sheet-forming expansion in the casting process. For example, a gel-phased reactant obtained by the extrusion and T-die may be cast using a cooling roll to be manufactured in a sheet type. A rate of the cooling roll may be controlled to control a sheet-forming expansion in the casting process. After performing the casting process, the sheet may be stretched in a machine direction (MD) and a transverse direction (TD), respectively. In an implementation, the sheet may be simultaneously stretched in both of a machine direction and a transverse direction.

Then, the diluent is extracted from the sheet stretched in a machine direction and a transverse direction. In an example embodiment, the extracting of the diluent may be performed using an organic solvent. For example, the sheet stretched in a machine direction and a transverse direction may be immersed into an organic solvent layer in a diluent extracting apparatus to extract the diluent. The organic solvent used in the extracting of the diluent may be a suitable solvent that is capable of extracting the diluent.

The extracting apparatus of the example embodiment may include a water layer formed on an organic solvent layer or an upper layer portion of the organic solvent extracting the diluent from the sheet. The water layer may be formed by phase-separation of water contained with the organic solvent.

Examples of the organic solvent may include methyl ethyl ketone, methylene chloride, hexane, and the like, which have high extraction efficiency and are easily dried. For example, in the case of using the liquid paraffin as a diluent, methylene chloride may be used as an organic solvent.

Organic solvents used in extracting the diluent may have a high volatility and toxicity. Thus, the organic solvent and water may be mixed together in order to suppress volatilization of the organic solvent. In the case of mixing the organic solvent with water, the water layer may be formed in an upper layer portion of the organic solvent in the extracting apparatus due to phase-separation of the organic solvent, and in the case of not mixing the organic solvent with water, an organic solvent layer may be formed in the extracting apparatus.

Referring to FIGS. 1 and 2, the sheet obtained by using the organic solvent and performing the diluent extracting process may be moved to the drying apparatus and may be dried.

The sheet according to an example embodiment may be dried by a drying apparatus. The drying apparatus may be, e.g., a drying apparatus that includes a drying roll. The drying apparatus including the drying roll may be provided with an inlet 13 so that the sheet is injected or introduced into the apparatus.

Physical properties of the separator may have an influence on a thickness of the separator. Accordingly, in the case in which the separator has generally even and uniform thickness, it may have uniform and excellent physical properties. The thickness of the separator may have a significant influence on the drying process of the sheet. Accordingly, depending on the drying process, drying defects such as wrinkles or drying marks on the separator may occur, and thus-manufactured separator may have a large deviation in thickness.

For example, in the case in which the sheet is exposed to air and is partially dried before the sheet is introduced into an inlet of the drying apparatus, the manufactured separator may have a different water content, and thus wrinkles and/or drying marks may occur on the separator, which may cause appearance defects and drying defects of the separator. In the case of the separator having drying defects, even though the separator is introduced into the drying apparatus and the drying process is actually performed, a difference in drying may occur depending on portions of the separator, such that the thickness throughout the separator may not be uniform and the deviation thereof may be large.

According to an example embodiment, the shortest distance d (for example, vertical distance) between an outlet 12 of the extracting apparatus and an inlet 13 of the drying apparatus may be controlled to prevent the separator from being pre-dried before injecting the separator into the drying apparatus.

For example, the shortest distance d between the outlet 12 of the extracting apparatus to the inlet 13 of the drying apparatus may be 100 mm or less, e.g., 80 mm or less, 60 mm or less, or 50 mm or less.

The shortest distance d between the outlet 12 of the extracting apparatus and the inlet 13 of the drying apparatus may mean a straight distance between a point at which the separator is exposed from the organic solvent to air for the first time and the inlet of the drying apparatus. For example, the outlet 12 of the extracting apparatus may mean a surface of the organic solvent layer in the extracting apparatus or a surface of water layer in the case in which the water layer is formed.

The separator may be moved in the manufacturing apparatus (for example, when the separator is moved from the extracting apparatus to the drying apparatus) at a rate of 7 to 50 mpm (meter per min), and time required for introducing the extracted separator from the outlet 12 of the extracting apparatus or the surface of the organic solvent layer (or the water layer formed on the organic solvent layer) to the inlet 13 of the drying apparatus may be 1 second or less.

In the above-described rate range, the distance d between the outlet 12 of the extracting apparatus and the inlet 13 of the drying apparatus may be controlled and the time required for injecting the separator into the drying apparatus may be decreased to thereby prevent the separator from being pre-dried, such that physical properties such as a thickness, a tensile strength, a puncture strength, and the like, of the separator may be uniformly controlled.

After extracting the diluent from the separator, a heat-setting process may be performed. The heat-setting process may be used to remove a residual stress of the dried sheet to decrease a thermal shrinkage rate of a final sheet, such that permeability, thermal shrinkage rate, strength, and the like, may be controlled depending on a temperature, a fixing ratio, and the like, at the time of heat-setting process.

The heat-setting process may be a process in which the extracted and dried sheet is stretched and/or contracted (shrunk) in at least one axial direction. In addition, the heat-setting process may be performed in a biaxial direction including both of a machine direction and a transverse direction. For example, the sheet may be stretched and/or contracted in a biaxial direction including both of a machine direction and a transverse direction, or the sheet may be stretched and contracted in any one axial direction and may be stretched or contracted in the other one axial direction.

For example, the heat-setting process may be a process in which the sheet is stretched and contracted (shrunk) in a machine direction. A sequence of performing the stretching process and the contracting process may be varied. For example, after stretching the sheet in a machine direction, the sheet stretched in a machine direction may be contracted in a machine direction. Through the heat-setting process including the stretching and contracting processes, the separator may have an improved strength and an improved thermal shrinkage rate to provide an increased heat resistance.

For example, the sheet may be stretched at a predetermined expansion in a machine direction or may not be stretched if needed, while performing a heat-setting at a melting point temperature, or lower, of the dried sheet.

In addition, a temperature condition at the time of heat-setting may be appropriately controlled at various temperature ranges, and the stretching in a machine direction and/or the contracting in a machine direction may be performed one or more times depending on desired strength, thermal shrinkage rate, and the like, of the separator, to thereby control a stretching expansion depending on a usage of the sheet.

Hereinafter, referring FIG. 3, a method for manufacturing a separator according to another example embodiment will be described.

Referring to FIG. 3, the method for manufacturing a separator according to the present example embodiment may include supplying water to the separator after extracting a diluent from the separator and before introducing the separator into the drying apparatus to dry the separator. Thus, the separator may be prevented from being pre-dried before introducing the separator to the drying apparatus. Thus, a separator having excellent uniformity in physical properties may be provided.

Processes which are not particularly separately described in detail are substantially the same as the previously-described method for manufacturing the separator according to the previous example embodiment. Hereinafter, the supplying of the water to the separator after extracting the diluent from the separator and before drying the separator from which the diluent is extracted (which may help prevent the separator from being pre-dried) will be described.

The supplying of the water to the separator may be performed by, e.g., supplying steam to the separator, using a spray injection, supplying water through a nozzle, etc. A plurality of methods may be used together.

The supplying of steam to the separator includes supplying the steam to the separator to suppress the separator from being dried. The steam supplied to the separator may be varied in temperature and amount. The use of the spray injection to the separator to supply water may be varied in view of a size, a temperature, and a sprayed amount of water particles by the spray injection.

Referring FIG. 3, in the present example embodiment, the supplying of the water may be performed using a nozzle 11. The use of the nozzle to supply water to the separator may be varied in view of a size, a length, and a shape of an inner diameter of the nozzle. An amount of water supplied to the separator through the nozzle or a supplying rate of water may be varied. According to an example embodiment, water may be supplied at a rate of 100 ml/sec or less, e.g., at a rate of 10 to 100 ml/sec, or 30 ml/sec to 70 ml/sec.

Within the above-described range, the separator may be effectively prevented from being pre-dried, and an extremely strong pressure may act on the separator to prevent modification of the separator.

According to the present example embodiment, the nozzle 11 may be installed at a drying apparatus of a separator. For example, the nozzle may be installed at the drying apparatus in a direction toward a moving passage of the separator, or may be installed at a peripheral part of an inlet of the drying apparatus so that water is supplied to the separator while the separator from which the diluent is extracted is moved to the drying apparatus.

The supplying of the water to the separator may be continuously or non-continuously performed in view of the number of supplying times before the separator is introduced into the inlet of the drying apparatus after extracting the diluent from the separator, and may be continuously performed after extracting the diluent from the separator and before injecting the separator into the inlet of the drying apparatus.

The supplied water may be separated from the organic solvent layer, such that a water layer may be formed in an upper layer portion of the organic solvent layer due to phase-separation.

The drying of the separator may be performed through a drying apparatus. An example of the drying apparatus of the separator includes a drying roll. The drying apparatus of the separator including the drying roll may be provided with an inlet in which the separator is introduced into an apparatus.

According to another example embodiment, a separator in which an average thickness is 7 μm to 20 μm and an average deviation of thicknesses with respect to the average thickness is 5% or less may be provided.

For example, the average thickness may be 10 μm to 20 μm, e.g., 12 μm to 18 μm, and an average deviation of thicknesses with respect to the average thickness may be 4% or less. In the separator according to an example embodiment, a general thickness may be uniform and thus physical properties may also be uniform, which may help prevent stability of the separator from being deteriorated.

In the present specification, term “average deviation” indicates a value obtained by calculating the sum of absolute values of deviations which are differences between physical property values measured at any point each and average values of corresponding physical properties, and calculating a value obtained by dividing the sum by the measured times as a percentage with respect to the average value. The average deviation of the corresponding physical properties may be shown in the following Equation 1, and in the Equation 1, as the average deviation value becomes smaller, physical property may become more uniform:

Average Deviation(%)=[(Σᵢ₌₁ⁿ|Ai−Aav|/n)/Aav]×100 [Equation 1]

In the Equation 1, “n” indicates a total number of points at which the corresponding physical property is measured or samples, “Ai” indicates physical property values measured in each point or sample, and “Aav” indicates an average value of the corresponding physical property.

In addition, “Σᵢ₌₁ⁿ|Ai−Aav|” indicates the sum of absolute values of deviations which are differences between physical property values measured at each point and average values of corresponding physical properties.

Methods for measuring an average thickness and an average deviation of the separator include the following examples: first, thicknesses of the separator are measured at five or more (e.g., ten) different points in a width direction using a scanning electron microscope (SEM) cross-sectional image and a thickness gauge and an average of the measured values at each point is calculated to obtain an average thickness. For example, in the case of the separator having a width of 500 mm, thicknesses may be measured for each 20 mm section in a width direction from one end portion of a width, and an average of the measured values is calculated to obtain an average thickness.

Then, deviations (which are difference between the average thickness and the measured thicknesses at each point) are calculated to obtain an average deviation according to the Equation 1. For example, the sum of absolute values of deviations of thicknesses at each point is divided into the number of measuring times and is calculated as a percentage with respect to the average thickness, thereby obtaining an average deviation.

In the separator of the present example embodiment, an average puncture strength may be 690 gf or more, and an average deviation of the puncture strengths with respect to the average puncture strength may be 10% or less. For example, the average puncture strength may be 700 gf or more, and an average deviation of the puncture strengths may be 8% or less, for example, 6% or less. In the described range, the strength may be uniform and the strength which is appropriate for the separator may be secured.

Methods for measuring an average puncture strength and an average deviation of the separator include the following examples: a separator is cut at five or more (e.g., ten) different points at predetermined intervals in a width direction and a length direction (for example: width (MD) 50 mm×length (TD) 50 mm) so as to have predetermined sizes, respectively, to manufacture each sample. Then, each sample is put onto a hole having a diameter of 10 cm and power when the sample is punctured while pressing the sample with a probe of 1 mm is measured by using a G5 apparatus manufactured by GATO Tech Co., Ltd. Puncture strength of each sample cut at different points are measured and an average value of the measured values is calculated to obtain an average puncture strength.

After differences in the measured average puncture strength and values of puncture strength of each sample measured at each point are calculated, the sum of absolute values of deviations of each sample is divided into the number of measured times and is calculated as a percentage with respect to the average puncture strength, thereby obtaining an average deviation.

In the separator of the present example embodiment, an average tensile strength in a machine direction and a transverse direction may be 2,000 kgf/cm² or more, respectively, and average deviations of tensile strengths in a machine direction and a transverse direction with respect to the average tensile strength may be 8% or less, respectively.

For example, the average tensile strength may be 2,050 kgf/cm² or more, for example, 2,100 kgf/cm² or more in a transverse direction, and an average deviation of the tensile strengths in a transverse direction may be 7.5% or less, and an average deviation of the tensile strengths in a machine direction may be 7% or less.

In the above-described ranges, the strength may be uniform and adhesion that is appropriate for the separator may be secured.

Methods for measuring an average tensile strength and an average deviation of the separator include the following examples: the separator is cut at five or more (e.g., ten) different points in a width direction so as to have a rectangular shape having a predetermined size (for example: width (MD) 10 mm×length (TD) 50 mm) to manufacture each sample, and each sample is mounted on a universal testing machine (UTM) (tension tester) so that a measuring length is 20 mm and is stretched in a machine direction and a transverse direction, tensile strength of each sample is measured to obtain an average tensile strength of the measured values.

After differences in the measured average tensile strength and values of tensile strength of each sample measured at each point are calculated, the sum of absolute values of deviations of each sample is divided into the number of measured times and is calculated as a percentage with respect to an average tensile strength, thereby obtaining an average deviation.

In the separator of the present example embodiment, an average permeability may be 400 sec/100 cc or less, and an average deviation of permeabilities with respect to the average permeability may be 15% or less. For example, the average permeability may be 380 sec/100 cc or less, and an average deviation of the permeabilities with respect to the average permeability may be 14% or less.

The permeability is obtained by measuring time required for 100 cc of air to be passed through the separator. Methods for measuring an average permeability and an average deviation of the separator include the following examples: a separator is cut at 10 or more different points in a width direction so as to have a circular shape having a predetermined size (for example: 1 inch or more of diameter) to manufacture 10 samples. Then, time required for air of 100 cc to be passed through the separator at each point is measured by using a permeability tester (Asahi Seiko Co., Ltd.), and an average value of the measured values at each point is calculated to obtain an average permeability.

Next, differences between the measured average permeability and permeability values of samples measured at each point are calculated, and the sum of absolute values of deviations at each point is divided into the number of measured times and is calculated as a percentage with respect to the average permeability, thereby obtaining an average deviation.

An average thermal shrinkage rate measured in a machine direction and a transverse direction after leaving the separator according to an embodiment at 105° C. for 1 hour may be less than 5%, respectively, and may be 4.5% or less, respectively. For example, the average thermal shrinkage rate in a machine direction may be 1% or less, and the average thermal shrinkage rate in a transverse direction may be 4.0% or less. In the above-described ranges, stability against heat may be secured.

A method for measuring the average thermal shrinkage rate includes the following examples: a separator is cut at five or more (e.g., ten) different points in a width direction so as to have a predetermined size (for example: width (MD) 50 mm×length (TD) 50 mm) to manufacture each sample, and each sample at each point is left in an oven at 105° C. for 1 hour. Then, a degree of shrinkage in an MD direction and a TD direction of each sample is measured to obtain an average thermal shrinkage rate.

In the separator of the present example embodiment, a porosity may be 20 to 60% and an average deviation with respect to the average porosity may be 15% or less. For example, the porosity may be 20 to 50%. In the above-described range, the permeability may be excellent and an electrolyte may be sufficiently impregnated, such that performance of a battery may be improved and a strength of the separator may be maintained.

Methods for measuring a porosity and an average deviation of the separator include, for example, the following method: a separator is cut at 10 different points so as to have a size of 10 cm×10 cm to manufacture samples. Then, volume (cm³) and mass (g) of each sample are measured, and each porosity is measured from the measured volume and mass, and density (g/cm³) of the separator using the following Equation 2:

Porosity(%)=(Volume−Mass/Density of Sample)/Volume×100

(Density of Sample=Density of used polyolefin-based resin(for example: polyethylene)) [Equation 2]

Next, differences between the measured average porosity and porosity values of each sample are calculated, and the sum of absolute values of each deviation is divided into the number of measured times and is calculated as a percentage with respect to the average porosity, thereby obtaining an average deviation.

According to another example embodiment, an electrochemical battery including a polyolefin porous separator, a cathode, and an anode, and filled with an electrolyte may be provided. The polyolefin-based porous separator may be a separator manufactured by a method for manufacturing a separator according to an example embodiment.

For example, according to the present example embodiment, an electrochemical battery including a cathode, an anode, a polyolefin-based porous separator and an electrolyte may be provided, wherein, in the separator, an average thickness in a machine direction and a transverse direction is 7 μm to 20 μm, respectively, average deviations of thicknesses in a machine direction and a transverse direction with respect to the average thickness are 5% or less, respectively, an average permeability is 400 sec/100 cc or less, and an average deviation of permeabilities with respect to the permeability is 15% or less.

The electrochemical battery of the present example embodiment may be lithium secondary batteries such as a lithium metal secondary battery, a lithium ion secondary battery, a lithium polymer secondary battery, and a lithium ion polymer secondary battery.

Examples of the method for manufacturing an electrochemical battery are as follows: after the polyolefin-based porous separator according to an example embodiment is positioned between a cathode and an anode, a battery may be manufactured in a scheme in which an electrolyte is filled between the cathode and the anode.

An electrode configuring the electrochemical battery of the present example embodiment may be manufactured in a form in which electrode active materials are settled in an electrode current collector by a general method.

A cathode active material among the electrode active materials used in the present example embodiment may be a general cathode active material.

Examples of the cathode active material include a lithium manganese oxide, a lithium cobalt oxide, a lithium nickel oxide, a lithium iron oxide, a lithium composite oxide which is a combination thereof, and the like.

An anode active material among the electrode active materials used in the present example embodiment may be a general anode active material.

Examples of the anode active material include lithium absorption materials such as lithium metal, lithium alloy, carbon, petroleum coke, activated carbon, graphite, other carbons, and the like.

The electrode current collector used in the present example embodiment may be a general electrode current collector.

Examples of materials of a cathode current collector among the electrode current collectors include aluminum, nickel, a foil manufactured by a combination thereof, and the like.

Examples of materials of an anode current collector among the electrode current collectors include copper, gold, nickel, a copper alloy, a foil manufactured by a combination thereof, and the like.

The electrolyte may be an electrolyte suitable for an electrochemical battery.

In the electrolyte, a salt having a structure such as A⁺B⁻ may be dissolved or dissociated in an organic solvent.

Examples of the A⁺ include alkali metal cations such as Li⁺, Na⁺ and K⁺ and cations obtained by combinations thereof.

Examples of the B⁻ include anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻, and anions obtained by combinations thereof.

Examples of the organic solvent may be propylene carbonate (PC), ethylene carbonate (EC), diethyl carbonate (DEC), dimethyl carbonate (DMC), dipropyl carbonate (DPC), dimethyl sulfoxide (DMSO), acetonitrile, dimethoxyethane, diethoxyethane, tetrahydrofuran (THF), N-methyl-2-pyrrolidone (NMP), ethyl methyl carbonate (EMC), γ-butyrolactone (GBL), etc. The organic solvent may be used alone or as a mixture of two or more kinds thereof.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Examples 1 and 2

### Method for Manufacturing Polyolefin-Based Porous Separator Having Distance Between Outlet of Extracting Apparatus and Inlet of Drying Apparatus of 100 mm or Less

### Example 1

A high-density polyethylene (HDPE) in 30 parts by weight, manufactured by Mitsui Chemical, Inc., and having a weight average molecular weight of 600,000 g/mol was supplied to a twin-screw extruder, and a liquid paraffin (Kukdong Oil & Chemicals Co., Ltd.) in 70 parts by weight was introduced into a twin-screw extruder to perform an extrusion.

After the extrusion, a gel phased reactant obtained by T-die was formed in a sheet type separator by using a cooling roll. The separator was stretched in a machine direction (MD) at a temperature of 105° C. and in a transverse direction (TD) at a temperature of 115° C. (stretching expansion 5×5).

The stretched polyethylene separator was immersed into a water-methylene chloride (MC) zone (including methylene chloride (Samsung Fine Chemicals Co., LTD.) and a water layer formed on the methylene chloride) to extract the liquid paraffin, and then, after the extraction of liquid paraffin, was moved to a drying roll to be dried. A distance between a surface of the water layer (water surface) and an inlet of the drying roll was set to be 50 mm, and a moving rate of the separator in a separator manufacturing apparatus was set to be 7 mpm.

Then, the dried sheet was heat-set at a temperature of 130° C., and a winding process was performed to manufacture a polyolefin-based porous separator.

### Example 2

A separator of Example 2 was manufactured in the same method as that of Example 1 above, except that high-density polyethylene (HDPE) in 85 parts by weight, having a weight average molecular weight of 600,000 g/mol and ultra high molecular weight polyethylene (UHMWPE) in 15 parts by weight, manufactured by Mitsui Chemical, Inc., and having a weight average molecular weight of 2,400,000 g/mol were mixed together and supplied to a twin-screw extruder, and a liquid paraffin in 70 parts by weight based on 30 parts by weight of the mixed resin (HDPE and UHMWPE) was introduced into the twin-screw extruder, and a distance between a surface of the water layer and an inlet of the drying roll was set to be 100 mm.

### Comparative Examples 1 to 3

### Method for Manufacturing Polyolefin-Based Porous Separator Having Distance Between Outlet of Extracting Apparatus and Inlet of Drying Apparatus of More than 100 mm

### Comparative Example 1

A separator of Comparative Example 1 was manufactured in the same method as that of Example 1 above, except that a distance between a surface of the water layer and an inlet of the drying roll was set to be 150 mm.

### Comparative Example 2

A separator of Comparative Example 2 was manufactured in the same method as that of Example 1 above, except that a distance between a surface of the water layer and an inlet of the drying roll was set to be 200 mm.

### Comparative Example 3

A separator of Comparative Example 3 was manufactured in the same method as that of Example 2 above, except that a distance between a surface of the water layer and an inlet of the drying roll was set to be 200 mm.

Compositions and manufacturing conditions of separators manufactured by Examples 1 and 2, and Comparative Examples 1 to 3 above, respectively, are shown in the following Table 1:

TABLE 1

| | | Inventive | Inventive | Comparative | Comparative | Comparative |
|---|---|---|---|---|---|---|
| | | Example 1 | Example 2 | Example 1 | Example 2 | Example 3 |
| Composition | HDPE | 30 | 25.5 | 30 | 30 | 25.5 |
| (Parts by | UHMWPE | — | 4.5 | — | — | 4.5 |
| Weight) | Liquid | 70 | 70 | 70 | 70 | 70 |
| | paraffin | | | | | |

| | | | | | |
|---|---|---|---|---|---|
| Distance (mm) Between | 50 | 100 | 150 | 200 | 200 |
| Surface of Water | | | | | |
| Layer And | | | | | |
| Inlet of Drying Roll | | | | | |

### Examples 3 and 4

### Method for Manufacturing Polyolefin-Based Porous Separator Including Process of Supplying Water to Separator Through Nozzle

### Example 3

A high-density polyethylene (HDPE) in 30 parts by weight, manufactured by Mitsui Chemical, Inc., and having a weight average molecular weight of 600,000 g/mol was supplied to a twin-screw extruder, and a liquid paraffin (Kukdong Oil & Chemicals Co., Ltd.) in 70 parts by weight was introduced into the twin-screw extruder to perform an extrusion.

After the extrusion, a gel phased reactant obtained by T-die was manufactured in a sheet typed separator by using a cooling roll. The separator was stretched in a machine direction (MD) at a temperature of 105° C. and in a transverse direction (TD) at a temperature of 115° C. (stretching magnification: 5×5).

The stretched polyethylene separator was immersed into methylene chloride (Samsung Fine Chemicals Co., LTD.) to extract the liquid paraffin and then moved to a drying roll so that the separator was dried. Here, water was supplied to the separator from a nozzle installed at a lower portion of the inlet of the drying roll at a rate of 50 ml/sec and water was continuously supplied before the separator was inject into the inlet of the drying roll.

Then, the dried sheet was stretched in a transverse direction at a temperature of 130° C. while performing a heat-setting process, and a winding process was performed to manufacture a polyolefin-based porous separator having a final stretching expansion of 5×5 in a machine direction (MD) and a transverse direction (TD).

### Example 4

A separator of Example 4 was manufactured in the same method as that of Example 3 above, except that high-density polyethylene (HDPE) in 85 parts by weight, having a weight average molecular weight of 600,000 g/mol and ultra high molecular weight polyethylene (UHMWPE) in 15 parts by weight, manufactured by Mitsui Chemical, Inc., and having a weight average molecular weight of 2,400,000 g/mol were mixed together and supplied to a twin-screw extruder, and a liquid paraffin in 70 parts by weight based on 30 parts by weight of the mixed resin (HDPE and UHMWPE) was introduced into the twin-screw extruder.

### Comparative Examples 4 and 5

### Method for Manufacturing Polyolefin-Based Porous Separator not Including Process of Supplying Water to Separator

### Comparative Example 4

A separator of Comparative Example 4 was manufactured in the same method as Example 3 above except that the process of supplying water to the separator in Example 3 was not performed.

### Comparative Example 5

A separator of Comparative Example 5 was manufactured in the same method as Example 4 above except that the process of supplying water to the separator in Example 4 was not performed.

Compositions and manufacturing conditions of separators manufactured by Examples 3 and 4, and Comparative Examples 4 and 5 above, respectively, are shown in the following Table 2:

TABLE 2

| | | | | Compara- | Compara- |
|---|---|---|---|---|---|
| | | Exam- | Exam- | tive | tive |
| | | ple 3 | ple 4 | Example 4 | Example 5 |
| Composition | HDPE | 30 | 25.5 | 30 | 25.5 |
| (Parts By | UHMWPE | — | 4.5 | — | 4.5 |
| Weight) | Liquid | 70 | 70 | 70 | 70 |
| | Paraffin | | | | |

| | | | | |
|---|---|---|---|---|
| Whether or Not Water | Sup- | Sup- | Not Sup- | Not Sup- |
| Is Supplied | plied | plied | plied | plied |
| Water Supplying Rate | 50 | 50 | — | — |
| (ml/sec) | | | | |

### Experimental Example 1

### Evaluation on Appearance of Separators

Appearance of separators manufactured by Examples and Comparative Examples above, respectively, were observed and appearance properties thereof were evaluated as follows. A case in which one or more drying marks or wrinkles were observed in each separator was evaluated as a ‘defective’ case, and a case in which one or more drying marks or wrinkles were not observed in each separator was evaluated as an ‘excellent’ case.

### Experimental Example 2

### Measurement of Average Thickness and Average Deviation of Separators

The following experiments were performed in order to measure average thicknesses of the separators manufactured by Examples and Comparative Examples above.

Thicknesses of separators manufactured by Examples and Comparative Examples were measured for each 20 mm section in a width direction from one terminal end part of a width of the separator by using a thickness gauge (Mitutoyo Corporation, Litematic VL-50), and an average value (Av) of thickness values (A1 to A10) measured at 10 points (n) was calculated to obtain an average thickness.

Then, as described in the following Equation 1, differences between thicknesses at each point and average thickness were calculated and an average value of absolute values of deviations at each point was calculated to obtain an average deviation (%) as a percentage with respect to the average thickness.

Average Deviation(%)=[(Σᵢ₌₁ⁿ|Ai−Aav|/n)/Aav]×100 [Equation 1]

In the Equation 1, n indicates a total number of points at which the corresponding physical property was measured, Ai indicates physical property values measured in each point, and Aav indicates an average value of the corresponding physical property. In addition, Σᵢ₌₁ⁿ|Ai−Aav| indicates the sum of absolute values of deviations which are differences between physical property values measured at each point and average values of corresponding physical properties.

### Experimental Example 3

### Measurement of Average Puncture Strength and Average Deviation of Separators

The following experiments were performed in order to measure average puncture strengths of the separators manufactured by Examples and Comparative Examples above.

Samples of the separators manufactured by Examples and Comparative Examples above were cut at 10 different points in a predetermined size of width (MD) 50 mm×length (TD) 50 mm, and then, by using a G5 equipment manufactured by GATO Technology, Ltd., the sample was put onto a hole having a diameter of 10 cm and power when the sample was pierced while pressing the sample with a probe of 1 mm was measured. The puncture strength of each sample was measured and an average puncture strength (Aav) was calculated.

Deviations between the measured average puncture strength and the puncture strength of each sample obtained at each point were obtained, and an average deviation (%) was calculated by the same method as the Experimental Example 2 above.

### Experimental Example 4

### Measurement of Average Tensile Strength and Average Deviation of Separators

The following experiments were performed in order to measure average tensile strengths of the separators manufactured by Examples and Comparative Examples above.

Separators manufactured by Examples and Comparative Examples above were cut at 10 different points in a rectangular shape of width (MD) 10 mm×length (TD) 50 mm to manufacture 10 samples, and each sample was mounted on a universal testing machine (UTM) (tension tester) so that a measuring length is 20 mm, stretched, and average tensile strength (Aav) in an MD direction and a TD direction was measured, respectively, and deviations which are differences between the tensile strengths measured from each sample and the average tensile strength was calculated to obtain an average deviation (%) as the same method as Experimental Example 2.

### Experimental Example 5

### Measurement of Average Permeability and Average Deviation of Separators

The following experiments were performed in order to measure average permeabilities of the separators manufactured by Examples and Comparative Examples above.

Separators manufactured by Examples and Comparative Examples above were cut at 10 different points in a width direction so as to have a circular shape having a diameter of 1 inch or more to manufacture 10 samples, and time required for air of 100 cc to be passed through samples at each point was measured by using a permeability tester (Asahi Seiko Co., Ltd.). The required time was measured five times and an average value thereof was calculated to obtain an average permeability, and then differences between permeabilities obtained from each measuring sample and an average permeability (Aav) were calculated to obtain deviations, and an average deviation (%) was calculated as the same method as Experimental Example 2.

### Experimental Example 6

### Measurement of Average Thermal Shrinkage Rate and Average Deviation of Separators

The following experiments were performed in order to measure thermal shrinkage rate of the separators manufactured by Examples and Comparative Examples above.

Separators manufactured by Examples and Comparative Examples above were cut at 10 different points in a shape of width (MD) 50 mm×length (TD) 50 mm to manufacture 10 samples. Each sample was left in an oven at 105° C. for 1 hour, a degree of shrinkage in an MD direction and a TD direction of samples cut at each point was measured to obtain an average thermal shrinkage rate (Aav) in each direction, and differences between the measured average thermal shrinkage rate and thermal shrinkage rates of the samples at each point were calculated to obtain an average deviation which is an absolute value of an average value of deviations at each point, and then an average deviation (%) was calculated as the same method as Experimental Example 2.

### Experimental Example 7

### Measurement of Porosity and Average Deviation of Separators

The following experiments were performed in order to measure porosity of the separators manufactured by Examples and Comparative Examples above.

The separator was cut into a size of width 10 cm×length 10 cm at 10 different points to manufacture samples. Then, volume (cm³) and mass (g) of each sample were measured, each porosity was measured from the measured volume and mass, and density (g/cm³) of the separator using the following Equation 2 to calculate an average porosity, differences between the porosities at each measuring sample and the average porosity (Aav) were calculated to obtain deviations, and an average deviation (%) was calculated by the same method as Experimental Example 2 above.

Porosity(%)=(Volume−Mass/Density of Sample)/Volume×100

(Density of Sample=Density of used polyolefin-based resin(for example: polyethylene)) [Equation 2]

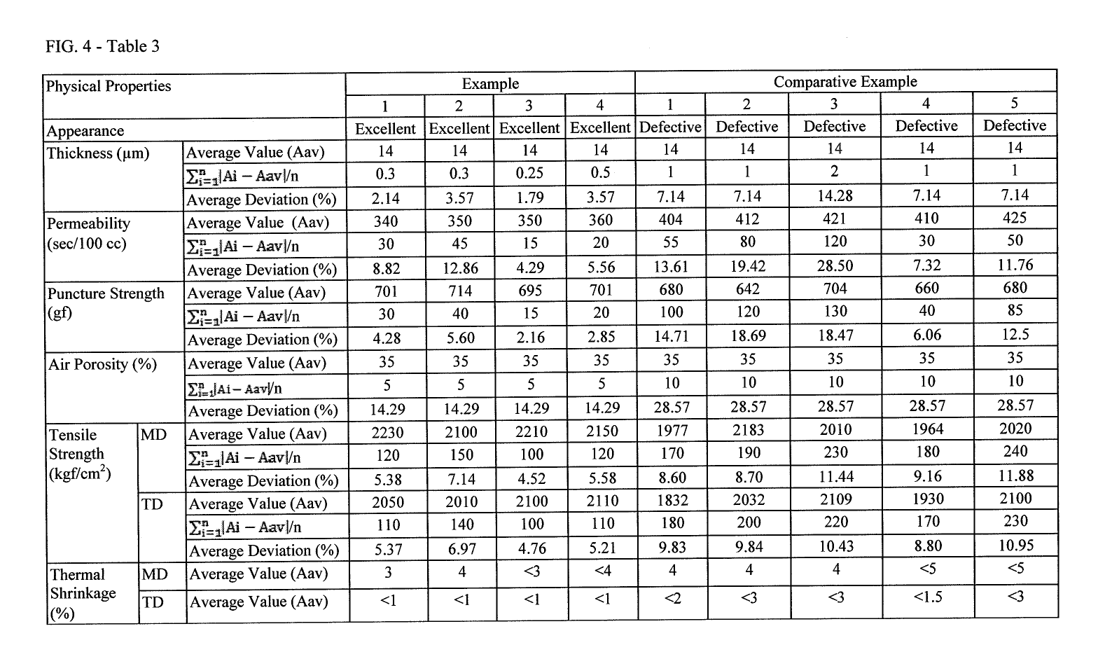

Measuring results of Experimental Examples 1 to 7 above are shown in FIG. 4, Table 3.

Referring to Table 3, Examples 1 and 2 corresponded to cases that separators were manufactured so that distance between an outlet of an extracting apparatus and an inlet of a drying apparatus was 100 mm or less, and a moving distance from the extraction of the liquid paraffin of the separator and to the drying apparatus was short, and a moving time was shortened, thereby helping to suppress drying of the separator before the separator was moved to the drying apparatus. Thus, the average deviation of the thicknesses of the separator was 5% or less, such that separators having significantly uniform thickness were manufactured.

In addition, in Examples 3 and 4 corresponding to cases that water was supplied to the separator while moving the separator to the drying apparatus after extracting the diluent from the separator, the separator was prevented from being pre-dried before the separator was moved to the drying apparatus. Thus, the average deviation of thicknesses with respect to the average thickness of the separator was measured to be 5% or less, such that the separator having significantly uniform thickness was manufactured.

In Examples 1 and 2 corresponding to the separators having uniform thickness, appearance properties were excellent, and uniformity in physical properties, including permeability, puncture strength, tensile strength, and thermal shrinkage rate, were excellent, as compared to Comparative Examples.

By way of summation and review, a battery having high power and large capacitance for being used in an electric automobile, and the like has been demanded in accordance with the trend toward lightness and miniaturization of the electrochemical battery for increasing portability of electronic apparatuses. Accordingly, a separator having excellent shape stability against a high temperature and a high tension in order to improving producibility of a large capacitance battery as well as having small thickness and light weight is desired.

It may be advantageous for the separator to show uniform physical properties throughout, in view of an improvement in stability and long-term reliability of the battery. The physical properties of the separator may be varied depending on components of a composition for a separator. However, even among the separators manufactured using the same composition, the physical properties of the finally manufactured separator may be different depending on methods for manufacturing separators and process conditions in manufacturing the separator. In addition, deviation in the physical properties per each portion in a single separator may also be varied. Therefore, in order to manufacture the separator having uniform physical properties throughout, it may be important to appropriately control a process for manufacturing a separator.

Methods may be selected for improving heat resistance or tensile strength of the separator to thereby improve average physical properties throughout the separator. A method for manufacturing a separator having high uniformity in physical properties throughout the separator, and a separator made thereby, are desired.

As described above, embodiments may provide a separator having excellent uniformity in physical properties by controlling a diluent extracting process and a drying process during a process for manufacturing a separator to decrease deviation in physical properties including a tensile strength, and a puncture strength as well as a thickness of the separator, and a method for manufacturing the same.

In addition, embodiments may provide a separator having a uniform thickness and uniform physical properties by helping to prevent the separator from being pre-dried before introducing the separator into a drying apparatus at the time of manufacturing the separator, and a method for manufacturing the same.

Further, embodiments may provide an electrochemical battery having an improved stability using a separator having excellent uniformity in physical properties.

Embodiments may provide a separator having excellent uniformity in physical properties by controlling the shortest distance between an outlet of an extracting apparatus and an inlet of a drying apparatus, and/or supplying water to the separator after extracting the diluent from the separator and before injecting the separator into the drying apparatus to dry the separator, which may help prevent the separator from being pre-dried before the separator (from which the diluent is extracted) is introduced into the drying apparatus. Thus, a method for manufacturing a separator having decreased deviation in the physical properties in the single separator, and thus having improved uniformity in physical properties throughout the separator, may be provided.

According to an embodiment, a method for manufacturing a separator may provide a separator having excellent uniformity in physical properties by controlling a diluent extracting process and a drying process during a process for manufacturing the separator. A method for manufacturing the separator may include controlling the shortest distance between an outlet of an extracting apparatus and an inlet of a drying apparatus, and/or supplying water to the separator after extracting the diluent from the separator and before injecting the separator into the drying apparatus to dry the separator. The method may help prevent the separator from being pre-dried before the separator is introduced into the drying apparatus, and a separator having uniformity in physical properties may be provided.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

Explanation of reference characters in drawings
10 An inlet of a drying apparatus
11 A nozzle for supplying water
12 An outlet of an extracting apparatus
13 An inlet of a drying apparatus
d The distance between an outlet of an extracting apparatus and an inlet of a drying apparatus

What is claimed is:

1. A method for manufacturing a polyolefin-based porous separator, the method comprising:
forming a sheet containing a polyolefin-based resin and a diluent;
extracting the diluent from the sheet by using an extracting apparatus; and
forming a separator by drying the extracted sheet using a drying apparatus provided with an inlet,
wherein the shortest distance between an outlet of the extracting apparatus and an inlet of the drying apparatus is 100 mm or less.

2. The method as claimed in claim 1, wherein the diluent is a liquid paraffin.

3. The method as claimed in claim 1, wherein the drying apparatus is a drying roll.

4. The method as claimed in claim 1, wherein the extracting of the diluent from the separator includes immersing the separator into a solvent layer in the extracting apparatus.

5. The method as claimed in claim 4, wherein the solvent layer includes a water layer formed on an organic solvent layer or an upper layer portion of the organic solvent.

6. The method as claimed in claim 4, wherein the shortest distance between a surface of the solvent layer and an inlet of the drying apparatus is 100 mm or less.

7. A method for manufacturing a polyolefin-based porous separator, the method comprising:
forming a sheet containing a polyolefin-based resin and a diluent;
extracting the diluent from the sheet;
forming a separator by drying the extracted separator using a drying apparatus provided with an inlet; and
supplying water to the separator after the extracting of the diluent and before the drying of the extracted separator.

8. The method as claimed in claim 7, wherein the diluent is a liquid paraffin.

9. The method as claimed in claim 7, wherein the drying apparatus is a drying roll.

10. The method as claimed in claim 7, wherein the extracting of the diluent from the separator includes immersing the separator into a solvent layer in the extracting apparatus.

11. The method as claimed in claim 10, wherein the solvent layer includes a water layer formed on an organic solvent layer or an upper layer portion of the organic solvent.

12. The method as claimed in claim 10, wherein the shortest distance between a surface of the solvent layer and an inlet of the drying apparatus is 100 mm or less.

13. The method as claimed in claim 7, wherein the supplying of the water is performed by supplying steam.

14. The method as claimed in claim 7, wherein the supplying of the water is performed by a spray injection.

15. The method as claimed in claim 7, wherein the supplying of the water is performed by supplying water through a nozzle.

16. The method as claimed in claim 15, wherein water is supplied at a rate of 100 ml/sec or less through the nozzle.

17. The method as claimed in claim 7, wherein the supplying of the water is continuously performed after extracting the diluent and before injecting the separator into the inlet of the drying apparatus.

18. A polyolefin-based porous separator of which an average thickness is 7 μm to 20 μm, an average deviation of thicknesses with respect to the average thickness is 5% or less, an average puncture strength is 690 gf or more, and an average deviation of puncture strengths with respect to the average puncture strength is 10% or less.

19. The polyolefin-based porous separator as claimed in claim 18, wherein average tensile strengths in a transverse direction (TD) and a machine direction (MD) are 2,000 kgf/cm² or more, respectively, and average deviations of tensile strengths in a transverse direction (TD) and a machine direction (MD) with respect to the average tensile strengths are 10% or less, respectively.

20. The polyolefin-based porous separator as claimed in claim 18, wherein an average permeability of the polyolefin-based porous separator is 400 cc/100 sec or less, and an average deviation of permeabilities with respect to the average permeability is 15% or less.

21. The polyolefin-based porous separator as claimed in claim 18, wherein thermal shrinkage rates measured in a transverse direction (TD) and a machine direction (MD) after leaving the separator at 105° C. for 1 hour are 5% or less, respectively.

22. The polyolefin-based porous separator as claimed in claim 18, wherein a porosity of the polyolefin-based porous separator is 20 to 60%.

23. An electrochemical battery, comprising:
a cathode;
an anode;
a polyolefin-based porous separator; and
an electrolyte,
wherein the polyolefin-based porous separator is the separator as claimed in claim 18.

24. The electrochemical battery as claimed in claim 23, wherein the electrochemical battery is a lithium secondary battery.
